(19) United States
(12) Patent Application Publication
(10) Pub. No.: US 2023/0219251 A1
(43) Pub. Date: Jul. 13, 2023

(54) MULTIFUNCTIONAL WOOD PRESERVATIVE COMPOSITION AND WOOD PRESERVATION TREATMENT METHOD USING THE SAME

(71) Applicant: KOREA INSTITUTE OF SCIENCE AND TECHNOLOGY, Seoul (KR)

(72) Inventors: Jinqyu KIM, Seoul (KR); Jae-Gwan PARK, Seoul (KR); Kyung Tae HONG, Seoul (KR); Soo Chang SONG, Seoul (KR); Jin Gu KANG, Seoul (KR)

(21) Appl. No.: 17/707,975

(22) Filed: Mar. 30, 2022

(30) Foreign Application Priority Data
Jan. 7, 2022 (KR) 10-2022-0002718

(51) Int. Cl. B27K 3/16; A01N 59/14; A01P 17/00; A01P 3/00

(52) U.S. Cl. CPC B27K 3/163; A01N 59/14; A01P 17/00; A01P 3/00; B27K 2240/20; B27K 2240/30

(57) ABSTRACT

The present invention relates to a multifunctional wood preservative composition containing a compound prepared by reaction of hydrazine hydrate and boric acid and to a method for wood preservation treatment using the same.

The wood preservative composition of the present invention can not only impart flame retardant, insect-repellent, rot-resistant, insect-repellent, and rust-proof effects to wood, such as various wooden structures including wooden cultural assets, but also causes no whitening and makes relatively fewer color changes for dancheong. Furthermore, the wood preservative composition of the present invention is provided as a one-component type liquid and thus can save time and costs for wood treatment and is convenient to use.

### TECHNICAL FIELD

The present invention relates to a multifunctional wood preservative composition and a wood preservation treatment method using the same.

### BACKGROUND ART

Korea traditionally has many wooden cultural assets, which, unlike those of other countries, are characterized by being decorated with dancheong (Dancheong, mainly in Korea, is traditionally decorated with multicolored patterns on wooden buildings, and is also called shortwall. Functionally, it serves to prevent the wood from rotting in the wind and rain. Dancheong draws patterns according to certain rules based on blue/red/yellow/white/black colors on the basis of the theory of the five elements).

Wood has high strength considering its light weight, is easy to handle or process, requires less energy for manufacturing, imparts a pleasant feeling due to its humidity control properties, and is advantageous for warming due to its low conductivity of heat or electricity. In addition, wood is a sustainable resource through planting despite its being felled and is still highly preferred as a building material since it is a carbon-neutral resource.

However, wood has disadvantages of biological deterioration and chemical deterioration. Biological deterioration means rotting due to white or brown rot fungi, surface discoloration due to the microorganism mold, and damage due to white ants, while chemical deterioration refers to its ease of combustion.

Wood preservatives are used to overcome such biological deterioration of wood. As wood preservatives, creosote was first introduced and used in 1681, and then ammoniacal copper chromate (ACC, 1928), pentachlorophenol (1931), chromated copper arsenate (CCA, 1933), ammoniacal copper arsenate (ACA, 1939), and the like were used. Due to problematic chromium and arsenic contained in the wood preservatives, ammoniacal copper quaternary (ACQ), micronized copper (MC), and the like, free from harmful metals, have been used since 1990. However, even copper, which is considered an indispensable element in wood preservatives, has been indicated as being hazardous.

Besides the aforementioned wood preservatives, phosphoric acid salts, phosphonic acid salts, sulfamic acid salts, and the like are used as wood preservatives. Patent documents related to phosphoric acid salt-based flame retardants include patent documents disclosing guanidine phosphate (Korean Patent No. 10-0917665), ethanolamine phosphate (Korean Patent No. 10-1286967), and ammonium phosphate (Korean Patent Nos. 10-1350975 and 10-1597986); patent documents related to phosphonic acid salt-based flame retardants include patent documents disclosing ammonium nitrilotris(methylene)trisphosphonate (Korean Patent No. 10-1980366, 10-1487365, and 10-1230386); and patent documents disclosing sulfamic acid salts (Korean Patent No. 10-1286967).

However, celadonite, which is used for underpainting of dancheong in Korean wooden cultural assets, has a seashell powder content of 80%, a main component of which is calcium carbonate. Hence, the application of a phosphoric acid salt-based flame retardant onto dancheong causes a reaction between a phosphoric acid salt and the seashell powder to generate calcium phosphate, which is a cause of whitening. Since phosphonic acid salts have an action of dissolving calcium carbonate therein through chelation, the application of a flame retardant containing this ingredient onto dancheong results in the dissolution of the seashell powder of dancheong, causing a significant change in color. In addition, sulfamic acid salts are flame retardants for wood and have a significantly lower flame-retardant performance than phosphoric acid salts, and cause metal corrosion and thus limit the use thereof.

Boron is the only element that can meet the concerns of ecosystems, requirements for environmental friendliness, and usefulness for Korean wooden cultural assets.

The most important factor for boron compounds to exhibit bio-resistance or flame retardancy in wood is the content of boron expressed as the boric acid equivalent (BAE). The solubility of boric acid or borax is low, 4-5%, at room temperature, and therefore a compound with a higher BAE as a wood preservative is required. Hence, ammonium pentaborate (APB) or disodium octaborate tetrahydrate (DOT) has been widely used as a wood preservative or a flame retardant, but these compounds are also only 10.6% and 11.6% BAE at room temperature, respectively.

Therefore, the present inventors endeavored to overcome the disadvantages of conventional wood preservatives and find a boron compound having a stable high solubility even at room temperature, and as a result, the present inventors have identified that a compound obtained by reacting hydrazine hydrate and boric acid is a low-viscosity solution even at high BAE levels, causes no crystal precipitation even when diluted, can impart, in an one-component type, flame-retardant, rot-resistant, insect-repellent, and anti-rust effects to wooden cultural assets, leaves neither seashell powder nor whitening on surfaces after wood treatment, and shows a comparatively small difference in colors of dancheong before and after the treatment with preservatives, thereby completing the present invention.

### DISCLOSURE

### Technical Problem

An aspect of the present invention is to provide a wood preservative composition containing a compound prepared using hydrazine hydrate (HH) and boric acid (BA) at a reaction molar ratio of 1:1-10.

Another aspect of the present invention is to provide a method for wood preservation treatment, the method including treating wood with the wood preservative composition of the present invention.

### Technical Solution

The present disclosure will be specifically set forth as follows. Each description and exemplary embodiment provided in this disclosure may also be applied to other descriptions and exemplary embodiments. That is, all combinations of various elements provided in this disclosure fall within the scope of the present disclosure. In addition, the scope of the present disclosure is not limited by the specific description below.

In accordance with an aspect of the present invention, there is provided a wood preservative composition containing a compound prepared using hydrazine hydrate (HH) and boric acid (BA) at a reaction molar ratio of 1:1-10.

The compound of the present invention is a compound synthesized from HH and BA, and for example, the compound may be prepared using HH and BA at a reaction molar ratio of 1:1-10, specifically 1:1-6, and more specifically 1:1-2, but is not limited thereto.

In an embodiment of the present invention, the synthesis of the compound H₂N₂·2H₃BO₃ was identified by reaction of HH and BA at a molar ratio of 1:2.

In the present invention, the compound of the present invention may be named hydrazine borate.

Besides the aforementioned compound of the present invention, stereoisomers thereof and salts thereof may also be included in the scope of the present invention, but the compound of the present invention is not limited thereto.

A wood preservative composition essentially needs to have a flame-retardant function for protecting wood from physical and chemical factors, such as fire, as well as rot-resistant and insect-repellent performance for protecting wood from biological deterioration factors.

As for a wood preservative composition containing a boron compound as a main ingredient, such as the compound of the present invention, the concentration of borate in the wood needs to be at least a predetermined value in order to control wood deterioration organisms, and the predetermined value is referred to as toxicity titer. The toxicity titer may be expressed as the boric acid equivalent (BAE) in terms of the concentration of boric acid. The toxicity titer against wood deterioration organisms is known to be 3.0 kg/m³ BAE for Coptotermes formosanus, <3.0 kg/m³ BAE for Reticulitermes speratus, 1.0-1.5 kg/m³ BAE for rot fungi, and 1.2 kg/m³ BAE for wood-boring insects. In a case of wood having a specific gravity of 0.5 (1 m^{a} of wood corresponding to 500 kg), 1.0-3.0 kg of a boron compound may be required to control wood deterioration organisms, and the concentration of use of the boron compound may be calculated as 0.6%.

The biological deterioration can be prevented with even a low concentration of boron compound as described above, but a boron compound having a boric acid with a significantly higher concentration than the aforementioned value, for example, at least 10 wt % BAE, is required to exhibit flame-retardant performance through surface treatment of wood. However, the boron compound may cause whitening on the surface of wood when the boron compound does not have a stable dissolution concentration at room temperature (FIG. 5).

The compound of the present invention has at least 10 wt %, 12 wt %, and 20 wt % BAE at room temperature and thus has an excellent flame-retardant function, can easily control biological deterioration, and shows a stable dissolution concentration at room temperature to cause no whitening on the surface of wood.

The composition of the present invention may further contain a surfactant and a flame-retardant aid. Specifically, the composition of the present invention may contain 3 wt % to 50 wt % of the compound of the present invention, 0.01 wt % to 5 wt % of a surfactant, and 0 wt % to 15 wt % of a flame-retardant aid.

For example, the composition of the present invention may contain 3 wt % to 70 wt %, specifically 10 wt % to 50 wt % of the compound of the present invention.

The compound of the present invention in a content higher than the aforementioned numerical range may cause the formation of crystals at room temperature, and the compound of the present invention in a content lower than the aforementioned numerical range may cause degradation in flame-retardant performance.

As another example, the composition of the present invention may contain 0.01 wt % to 5 wt %, specifically 0.1 wt % to 5 wt % of the surfactant.

The surfactant in a content higher than the aforementioned numerical range may cause a lot of bubbles during the treatment of wood, and the surfactant in a content lower than the aforementioned numerical range may cause the degradation in the infiltration into wood.

In the present invention, the surfactant may be at least one selected from the group consisting of an anionic surfactant, a cationic surfactant, and a non-ionic surfactant.

Examples of the anionic surfactant of the present invention may include an alkali salt of dodecylbenzenesulfonic acid, an alkali salt of an alpha-olefin sulfonic acid, an alkali salt of an alkyl benzene sulfonic acid, an alkali salt of a dialkylsulfosuccinic acid; an alkali salt of an alkyl phosphate, an alkali salt of an aminophosphonic acid, an alkali salt of an alkyl naphthalene acid, and an alkali salt of an alkyl allyl ether and, specifically a sodium salt of dodecylbenzenesulfonic acid and/or a sodium salt of an alpha-olefin sulfonic acid, but are not limited thereto.

Examples of the cationic surfactant of the present invention may be include a quaternary ammonium salt having 8 to 18 carbon atoms, a fatty acid amine acetate with 8 to 18 carbon atoms, a fatty acid imidazolium methosulfate with 12 to 18 carbon atoms, and a fatty acid imidazolium quaternary compound with 8 to 18 carbon atoms.

Examples of the quaternary ammonium salt having an alkyl group or aromatic group with 8 to 18 carbon atoms may be benzalkonium chloride, didecyl dimethyl ammonium chloride, di(hydrogenated tallow) alkyl dimethyl ammonium chloride (trade name: Arquad HT-75), dimethyl benzyl ammonium chloride, distearyl dimethyl benzyl ammonium chloride, and the like, but are not limited thereto.

Examples of the fatty acid amine acetate with 8 to 18 carbon atoms may be laurylamine acetate, oleylamine acetate, and the like, but are not limited thereto.

Examples of the fatty acid imidazolium methosulfate with 12 to 18 carbon atoms may be lauryl imidazolium methosulfate, stearyl imidazolium methosulfate, and the like, but are not limited thereto.

Examples of the fatty acid imidazolium quaternary compounds with 8 to 18 carbon atoms may be cetyl imidazolium quaternary, dodecyl imidazolium quaternary, and the like, but are not limited thereto.

Specifically, the anionic surfactant of the present invention may be a quaternary ammonium salt with 8 to 18 carbon atoms, and more specifically benzalkonium chloride, but is not limited thereto.

Examples of the non-ionic surfactant of the present invention may include an alkyl phenol with 6 to 12 carbon atoms, a fatty acid ester with 12 to 18 carbon atoms, a fatty acid ether with 12 to 18 carbon atoms, a trisiloxane, and an acetylene-structured ethylene oxide adduct, an amine oxide with 12 to 18 carbon atoms, and the like.

Examples of the alkyl phenol with 6 to 12 carbon atoms may include nonyl phenol, octyl phenol, and the like, but are not limited thereto.

Examples of the fatty acid ester with 12 to 18 carbon atoms may include sorbitan fatty acid ester and the like, but are not limited thereto.

Examples of the fatty acid ether with 12 to 18 carbon atoms may include polyoxyethylene lauryl ether, polyoxyethylene oleyl ether, polyoxyethylene allyl ether, and the like, but are not limited thereto.

Examples of the acetylene-structured ethylene oxide adduct may include SURFYNOL 104 (acetylene diol), Dynol 604, and the like, but are not limited thereto.

The amine oxide with 12 to 18 carbon atoms may have a structure of R1R2R3N→O, in which R1 has a linear, branched, or cyclic structure and R2 and R3 each independently have a linear, branched, or cyclic structure, and examples thereof may include lauryl dimethyl amine oxide, myristyl dimethyl amine oxide, and the like, but are not limited thereto.

Specifically, the non-ionic surfactant of the present invention may be an ethylene oxide adduct and, more specifically acetylene diol, but is not limited thereto.

As another example, the composition of the present invention may contain 0 wt % to 15 wt %, specifically 3 wt % to 10 wt % of a flame-retardant aid.

The flame-retardant aid has little or no flame-retardant effect of its own, but the use of the flame-retardant aid together with a wood preservative composition or a flame retardant enhances a flame-retardant effect compared with the use of the wood preservative composition or the flame retardant alone, thereby attaining a sufficient wood preservative or flame-retardant effect through a small amount of a wood preservative composition or a flame retardant.

The flame-retardant aid in a content higher than the aforementioned numerical range may cause the deterioration in whitening resistance.

In the present invention, the flame-retardant aid may be at least one selected from the group consisting of phosphoric acid or a salt thereof, sulfuric acid or a salt thereof, a halogen acid or a salt thereof, sulfamic acid or a salt thereof, boric acid or a salt thereof, and a phosphonic acid or a salt thereof.

Examples of the salt of phosphoric acid of the present invention may be monoammonium phosphate, diammonium phosphate, triammonium phosphate, monolithium phosphate, dilithium phosphate, trilithium phosphate, monosodium phosphate, disodium phosphate, trisodium phosphate, monopotassium phosphate, dipotassium phosphate, tripotassium phosphate, monoguanidine phosphate, diguanidine phosphate, a low-condensed ammonium polyphosphate with a condensation degree of 2-200, guanyl urea phosphate, an amine salt of phosphoric acid, a hydrazine salt of phosphoric acid, and the like, but are not limited thereto.

Examples of the salt of sulfuric acid of the present invention may be ammonium sulfate, lithium sulfate, sodium sulfate, potassium sulfate, an amine salt of sulfuric acid, a hydrazine salt of sulfuric acid, and the like, but are not limited thereto.

Examples of the salt of the halogen acid of the present invention may be ammonium chloride, lithium chloride, sodium chloride, potassium chloride, ammonium bromide, sodium bromide, potassium bromide, an amine salt of the halogen acid, a hydrazine salt of the halogen acid, and the like, but are not limited thereto.

Examples of the salt of sulfamic acid of the present invention may be guanidine sulfamate, ammonium sulfamate, lithium sulfamate, sodium sulfamate, potassium sulfamate, an amine salt of sulfamic acid, a hydrazine salt of sulfamic acid, and the like, but are not limited thereto.

Examples of the salt of boric acid of the present invention may be boric acid, borax, boron oxide, potassium pentaborate (KB₅O₇), potassium tetraborate (K₂B₄O₇), sodium metaborate (NaBO₂), ammonium pentaborate ((NH₄)₂B₁₀O₁₆·8H₂O), sodium octaborate (Na₂B₈O₁₃), lithium octaborate (Li₂B₈O₁₃), magnesium octaborate (MgB₆O₁₃), calcium octaborate (CaB₈O₁₃), an amine salt of boric acid, and the like, but are not limited thereto.

Examples of the sodium octaborate may be disodium octaborate tetrahydrate (DOT, Na₂B₈O₁₃·4H₂O), lithium octaborate (Li₂B₈O₁₃), and the like, but are not limited thereto.

Specifically, the salt of boric acid of the present invention may be sodium octaborate and more specifically DOT, but is not limited thereto.

Examples of the salt of phosphonic acid of the present invention may be an ammonium salt, an amine salt, a hydrazine salt of phosphonic acid, such as amino trimethylene phosphonic acid, 1-hydroxyethylene-1,1-diphosphonic acid, ethylene diamine tetramethylene phosphonic acid, hexamethylene diamine tetramethylene phosphonic acid, diethylene triamine pentamethylene phosphonic acid, and 2-phosphonobutane-1,2,4-tricarboxylic acid, but are not limited thereto.

Examples of the amine salt of phosphonic acid may be an ammonium amino trimethylene phosphonate and the like, but are not limited thereto.

Specifically, the salt of phosphonic acid of the present invention may be an amine salt of phosphonic acid, and more specifically an ammonium amino trimethylene phosphonate, but is not limited thereto.

The wood preservative composition of the present invention may have at least one effect selected from the following:

i) flame-retardant effect;

ii) discoloration-resistant effect;

iii) whitening-resistant effect;

iv) mold-proof effect;

v) rot-resistant effect;

vi) insect-repellent effect; and

vii) iron corrosion inhibiting effect.

Regarding the flame-retardant effect i) of the composition of the present invention, an embodiment of the present invention confirmed that the treatment of plywood with the compounds of the present invention having at least 12% boric acid equivalent (BAE) prepared in Example 2 or the wood preservative compositions containing the compounds in Examples 4, 5, and 6 showed excellent flame-retardant effects (Table 5).

Regarding the discoloration-resistant effect ii) of the composition of the present invention, an embodiment of the present invention confirmed that the treatment of wood with the compounds of the present invention prepared in Example 2 showed excellent dancheong discoloration inhibiting effects (Table 7).

Regarding the whitening-resistant effect iii) of the composition of the present invention, an embodiment of the present invention confirmed that the treatment of the seashell powder with the compound of the present invention prepared in Example 1 maintained a form of calcium carbonate in the seashell powder even after 72 hours, causing no reaction of the compound of the present invention with calcium carbonate, showing excellent whitening-resistant effects (FIG. 8). When the seashell powder was treated with a conventional wood preservative composition containing triethanolamine phosphate as a main ingredient (Comparative Example 1), calcium carbonate as a main component of the seashell powder reacted with triethanolamine phosphate to start to be transformed into calcium phosphate after 30 minutes and all transformed into calcium phosphate after 12 hours.

Regarding the mold-proof effect iv) of the composition of the present invention, an embodiment of the present invention confirmed that the treatment of plywood with the wood preservative composition of Example 3 showed no growth of molds, indicating excellent mold-proof effects (Table 10).

The “mold-proof effect” refers to an effect of inhibiting wood surface contamination fungi.

Regarding the rot-resistant effect v) of the composition of the present invention, an embodiment of the present invention confirmed that the treatment of wood with the wood preservative composition of Example 3 showed a significant decrement in wood weight reduction rate caused by white rot fungi and brown rot fungi, indicating excellent rot-resistant effects (Table 11).

The “rot-resistant effect” refers to an effect of inhibiting rot fungi of wood.

Regarding the insect-repellent effect vi) of the composition of the present invention, an embodiment of the present invention confirmed that as a result of investigating an insect-repellent effect against Reticulitermes speratus by placing a specimen sprayed with the wood preservative composition of Example 3 in a container, the wood weight reduction rate by Reticulitermes speratus was significantly decreased and the insecticidal rate was increased, indicating an excellent insect-repellent effect (Table 12).

Regarding the iron corrosion inhibiting effect vii) of the composition of the present invention, an embodiment of the present invention confirmed that the spraying of nailed wood with the wood preservative composition of Example 3 showed significant decreases in test nail weight reduction rate and iron corrosion rate, indicating excellent iron corrosion inhibiting effects (Table 13). On the other hand, the treatment with a conventional wood preservative composition containing guanidine sulfamate as a main ingredient (Comparative Example 4) showed significant increases in weight reduction rate of test nails and iron corrosion rate.

Especially, the composition of the present invention has excellent discoloration-resistant and whitening-resistant effects, and thus can be easily applied to Korean wooden cultural assets that have been painted in dancheong, for example, cultural assets designated as national treasures, treasures, local cultural properties, and the like managed by the Korean Cultural Heritage Protection Act as well as all other wooden architectures and wooden structures worth preserving.

Celadonite, which is used for underpainting of dancheong in Korean wooden cultural assets, has a seashell powder content of 80%, a main component of which is calcium carbonate. Hence, the application of a phosphoric acid salt-based flame retardant onto dancheong provokes a reaction between a phosphoric acid salt and the seashell powder to generate calcium phosphate, which is a cause of whitening. Since a phosphonic acid salt has an action of dissolving calcium carbonate therein through chelation, the application of a flame retardant containing this ingredient onto dancheong results in the dissolution of the seashell powder of dancheong, causing a significant change in color. In addition, sulfamic acid salts are flame retardants for wood and have a significantly lower flame-retardant performance than phosphoric acid salts, and cause metal corrosion and thus restrict the use thereof.

Hence, the composition of the present invention having excellent effects in terms of flame retardancy, discoloration resistance, whitening resistance, rot resistance, insect repellence, and inhibition of weight reduction due to iron corrosion can provide excellent effects for the conservation of wooden cultural assets as well as wood.

The above-described excellent effects of the composition of the present invention can be exhibited by containing a boron compound.

Boron compounds have low volatility, show strong toxicity to wood-damaging pests or microorganisms but low toxicity to mammals, exhibit colorlessness, odorlessness, and low rust resistance as aqueous solutions thereof, and are economical compared with copper. In addition, all of copper naphthenate, oxine copper, IPBC, ammoniacal copper zinc arsenate (ACZA), alkaline copper quaternary (ACQ), copper azoles (CA), acid copper chromate (ACC), micronized copper (MC), and the like, which are copper element-based wood preservatives currently in use, are of a fixed type showing little movement into the inside of wood, but a boric acid salt move into wood over time in the presence of an appropriate content of moisture in the wood, and such movement is known to be made for about 8 weeks. The boron-based preservatives have such characteristics and thus can also be applied to woods of refractory timber species, which were difficult to treat with copper-based chemicals, such as spruce or Douglas fir.

The most important factor for boron compounds to exhibit bio-resistance or flame retardancy in wood is the content of boron, expressed as the boric acid equivalent (BAE). The solubility of boric acid or borax is low, 4-5%, at room temperature, and therefore a compound with a higher BAE as a wood preservative is required. Hence, ammonium pentaborate (APB) or disodium octaborate tetrahydrate (DOT) has been widely used as a wood preservative or a flame retardant, but these compounds are also only 10.6% and 11.6% BAE at room temperature, respectively.

In this regard, Korean Patent No. 10-1460784 discloses a method for preparing a dilithium octaborate (LOB) compound as a compound having stable solubility at room temperature. The compound synthesized by way of the above method has 24.1% BAE at room temperature and has much higher dissolution stability at room temperature than conventional compounds, but has a limitation in that lithium hydroxide much more expensive than sodium hydroxide needs to be used.

U.S. Pat. No. 5,104,664 discloses a composition containing 40.6% of DOT, 47.5% of ethylene glycol, and 11.9% of polyethylene glycol with a molecular weight of 200. The resultant product obtained by way of the above method surprisingly has a dissolution stability of 48% BAE at room temperature, but the precipitation of crystals is merely inhibited even in supersaturated solubility due to the high viscosity of ethylene glycol or polyethylene glycol, and therefore, when such a composition needs to be diluted for the application to wood, the dilution of the composition with water causes the precipitation of crystals within one or several days due to a decrease in the viscosity of the solution, failing to reach the solubility of DOT.

Therefore, the compound of the present invention has low viscosity even at high BAE levels and thus has stable and high solubility even at room temperature without precipitation of crystals even when diluted (Table 14), so that the compound of the present invention is significant in that the compound is applied to a wood preservative composition. Especially, the compound of the present invention is superior compared with the conventional art in that even when wood is painted in dancheong, the compound of the present invention can preserve the colors of dancheong, unlike a phosphoric acid salt or a phosphonic acid salt that changes the colors of dancheong.

In accordance with another aspect of the present invention, there is provided a method for wood preservation treatment, the method including treating wood with the wood preservative composition.

The terms used herein are the same as described above.

In the method of the present invention, a method of treating wood with the composition of the present invention is not particularly limited as long as such a method is used in the art, and examples of the method may be spraying, immersing, pressurizing, or the like.

When wood is treated by spraying of the composition of the present invention, the treating may be performed by a single time or multiple times of spraying, and the amount of spraying may be, but not particularly limited to, 100 g/m² or more, 110 g/m² or more, 120 g/m² or more, 130 g/m² or more, or 140 g/m² or more per unit area.

### Advantageous Effects

The wood preservative composition of the present invention can not only impart flame-retardant, insect-repellent, rot-resistant, and rust-proof effects to wood, such as various wooden structures including wooden cultural assets, but also causes no whitening and makes relatively fewer color changes for dancheong. Furthermore, the wood preservative composition of the present invention is provided as a one-component type liquid and thus can save the time and costs for wood treatment and is convenient to use.

### BRIEF DESCRIPTION OF DRAWINGS

FIG. 1 shows infrared spectra of white powders obtained by evaporating and concentrating solutions, synthesized under conditions of #1 (left) and #2 (right) of Example 1, at 60° C. by an evaporation concentrator.

FIG. 2 shows X-ray diffraction spectra of white powders obtained by evaporating and concentrating solutions, synthesized under conditions of #1 (left) and #2 (right) of Example 1, at 60° C. by an evaporation concentrator.

FIG. 3 shows an X-ray diffraction (XRD) pattern of a powder obtained by drying the solution, synthesized under conditions of #2 of Example 1, at room temperature for 4 months.

FIG. 4 shows an XRD pattern of transparent crystals formed in the solution synthesized under conditions of #2 of Example 1 by leaving the solution at room temperature for 4 months.

FIG. 5 is a photograph showing the change in the appearance of wood according to the type of drug.

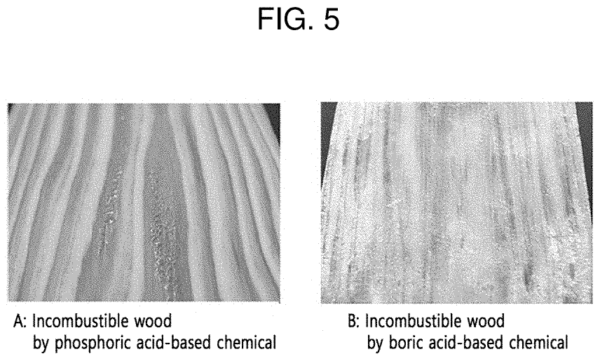

### DETAILED DESCRIPTION OF THE INVENTION

Hereinafter, preferable exemplary embodiments will be described for better understanding of the present invention. However, the following exemplary embodiments are provided merely to illustrate the present invention and not to restrict the scope of the present invention. The exemplary embodiments of the present invention are provided to illustrate the present invention more completely to those skilled in the art.

### Example 1: Synthesis of Hydrazine Borate

Hydrazine borates (#1 to #6) were synthesized by varying the amounts of boric acid (BA) and hydrazine hydrate (HH) while fixing the boric acid equivalent (BAE) level to 30 wt %.

Specifically, 150 g of BA was added, and HH was added at ratios shown in Table 1 after addition of water (distilled water), followed by reaction at a temperature of each reaction solution of 60° C. The termination time point of the reaction was when the solution became a transparent solution. The degree of precipitation was analyzed one day after the completion of the reaction.

TABLE 1

| | BA:HH | | | | | | |
|---|---|---|---|---|---|---|---|
| | reaction | | | | | | |
| Reaction | molar | | | Distilled | Total | | Precipitate |
| No. | ratio | BA | HH | water | amount | pH | formation*¹ |
| #1 | 1:1 | 150 g | 121.5 g | 228.5 g | 500 g | 9.50 | x |
| #2 | 2:1 | 150 g | 60.8 g | 289.2 g | 500 g | 8.42 | x |
| #3 | 3:1 | 150 g | 40.5 g | 309.5 g | 500 g | 7.45 | ○ |
| #4 | 4:1 | 150 g | 27.5 g | 322.5 g | 500 g | 6.13 | ○ |
| #5 | 5:1 | 150 g | 24.3 g | 325.7 g | 500 g | 6.33 | ○ |
| #6 | 6:1 | 150 g | 20.3 g | 329.7 g | 500 g | 6.59 | ○ |

*¹: x: No precipitates, ○: Precipitate formation

As a result, #1 and #2 resulted in transparent solutions, and #3 to #6 showed precipitate formation, identifying that as the proportion of boric acid in the ratio of BA and HH increase, the amount of precipitates increases. As a result of recovering and analyzing precipitates, all of the precipitates were BA.

The compound containing 1:1 of BA and HH had 65.9% BAE and the compound containing 2:1 of BA and HH had 79.4% BAE.

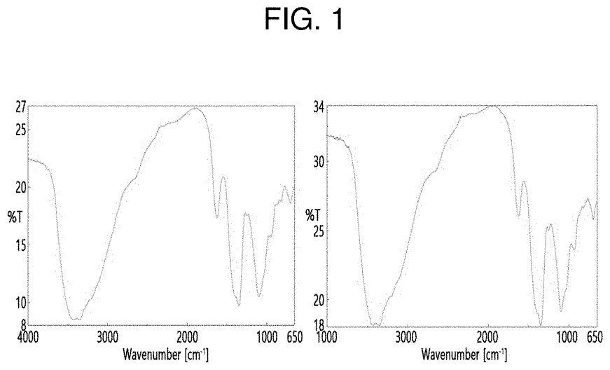

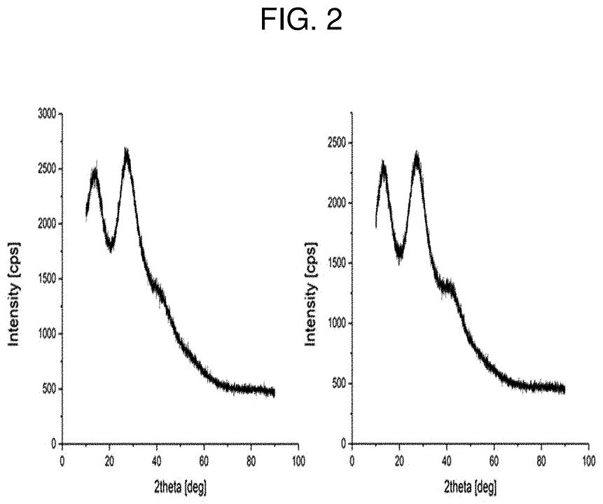

Then, as a result of evaporating and concentrating #1 and #2 at 60° C. by an evaporative concentrator, white solids corresponding to 28.7% and 23.9% of the weights of the raw specimens were obtained, and the infrared spectrum and X-ray diffraction (XRD) measurement results of these solids are shown in FIGS. 1 and 2, respectively. CHN elemental analysis results thereof are shown in Table 2 below.

TABLE 2

| | C | H | N |
|---|---|---|---|
| #1 of Example 1 | 0.34 | 5.71 | 27.1 |
| | 0.42 | 5.60 | 27.1 |
| Average | 0.38 | 5.66 | 27.10 |
| #2 of Example 2 | 0.36 | 4.85 | 20.1 |
| | 0.42 | 4.86 | 20.1 |
| Average | 0.39 | 4.86 | 20.10 |

As a result, it was identified that BA and HH reacted at a molar ratio of 2:1 [H₂N₂·2H₃BO₃], indicating that an excess of HH was present in #1.

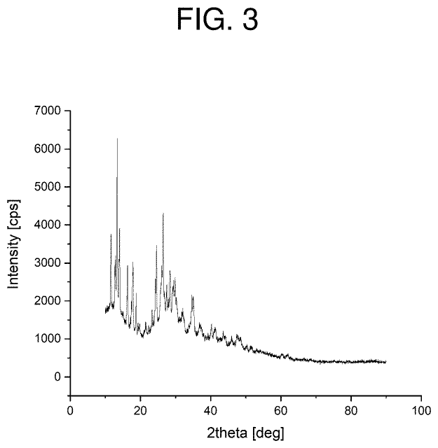

Meanwhile, the XRD pattern measurement results of a powder obtained by drying the solution synthesized under the conditions with respect to #2 at room temperature for 4 months are as shown in FIG. 3.

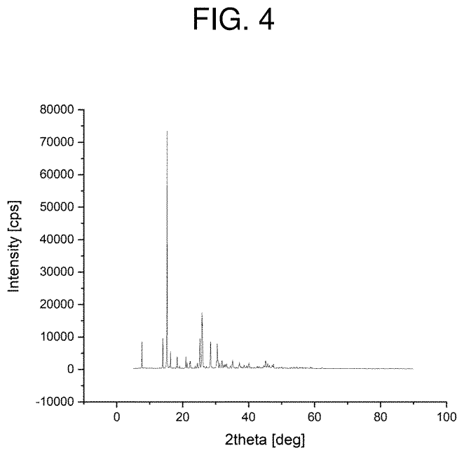

The XRD pattern measurement results of transparent crystals formed by leaving the solution synthesized under the conditions with respect to #2 at room temperature for 4 months are shown in FIG. 4.

### Example 2: Synthesis of Hydrazine Borates with Different Boric Acid Equivalent (BAE) Levels

Hydrazine borates (#7 to #11) with different BAE levels were synthesized by varying the amounts of BA and HH. Specifically, BA was added at proportions shown in Table 3 below, and water was added and HH was added, followed by reaction at a temperature of each reaction solution of 60° C. Then, the termination time point of the reaction was when the solution became a transparent solution. The degree of precipitation was analyzed one month after the completion of the reaction.

TABLE 3

| | | | | | Total | |
|---|---|---|---|---|---|---|
| Reaction | | | | | amount | |
| No | BAE | BA (g) | HH (g) | Water (g) | (g) | pH |
| #7 | 40 wt % | 100.0 | 40.6 | 109.4 | 250 | 8.45 |
| #8 | 50 wt % | 125.0 | 50.7 | 74.3 | 250 | 8.42 |
| #9 | 55 wt % | 137.5 | 55.7 | 56.8 | 250 | 8.41 |
| #10 | 60 wt % | 150.0 | 60.8 | 39.2 | 250 | 8.40 |
| #11 | 71 wt % | 178.3 | 71.7 | 0 | 250 | 8.37 |

As a result, all of the solutions were transparent solutions immediately after being prepared, but one month after the preparation, insoluble matter was deposited on the bottom in #9, #10, and #11, while colorless and transparent solutions were maintained in #7 and #8, indicating that a hydrazine borate solution was stable up to 50 wt % BAE at room temperature.

### Preparative Example 1: Preparation of Wood Preservative Composition

### Preparative Example 1-1: Preparation of Wood Preservative Composition (Example 3)

A wood preservative composition was prepared by adding 2 g of a 50% benzalkonium chloride solution to 100 g of a solution in which the hydrazine borate solution of #8 in Example 2 was diluted to 20 wt % BAE in distilled water.

### Preparative Example 1-2: Preparation of Wood Preservative Composition (Example 4)

A wood preservative composition was prepared by adding diammonium phosphate in a content of 5 wt % on the basis of a solid content and a 0.5% sodium dodecyl benzene sulfonate anionic surfactant to 100 g of a solution in which the hydrazine borate solution of #8 in Example 2 was diluted to 20 wt % BAE in distilled water.

### Preparative Example 1-3: Preparation of Wood Preservative Composition (Example 5)

A wood preservative composition was prepared by adding disodium octaborate tetrahydrate (DOT, Na₂B₈O₁₃·4H₂O) in a content of 7 wt % on the basis of a solid content and a 1.0% sodium α-olefin sulfonate anionic surfactant to 100 g of a solution in which the hydrazine borate solution of #8 in Example 2 was diluted to 20 wt % BAE in distilled water.

### Preparative Example 1-4: Preparation of Wood Preservative Composition (Example 6)

A wood preservative composition was prepared by adding ammonium amino trimethylene phosphonate in a content of 3 wt % on the basis of a solid content and a 1.0% Dynol 604 non-ionic surfactant to 100 g of a solution in which the hydrazine borate solution of #8 in Example 2 was diluted to 20 wt % BAE in distilled water.

### Preparative Example 1-5: Preparation of Wood Preservative Composition Containing Phosphoric Acid Salt as Main Ingredient (Comparative Example 1)

A colorless transparent wood preservative composition having pH of 7.37 and containing triethanolamine as a main ingredient was prepared by placing 50.0 g of 85% phosphoric acid and 84.3 g of distilled water in a 500 mL beaker and adding 115.7 g of triethanolamine for 3 hours.

### Preparative Example 1-6: Preparation of Wood Preservative Composition Containing Ammonium Salt as Main Ingredient (Comparative Example 2)

A wood preservative composition was prepared by diluting ammonium nitilotis(methylene)trisphosphonate (Amgard RD-1, Rhodia) to a solid content of 20% in distilled water.

### Preparative Example 1-7: Preparation of Wood Preservative Composition Having Boric Acid Salt as Main Ingredient (Comparative Example 3)

In a 1 L beaker, 240 g of ethylene glycol and 60 g of polyethylene glycol were placed and mixed, and then the temperature was raised to 45° C. In this situation, mixing was conducted while 200 g of DOT was slowly added, and the temperature was raised to 90° C. while the mixture was stirred well. Thereafter, the mixture was heated until it became a transparent solution. After the solution was confirmed to be transparent, the solution was cooled to room temperature to thereby prepare 500 g of a wood preservative composition having an effective boric acid content of 48.0% and a high viscosity.

### Preparative Example 1-8: Preparation of Wood Preservative Composition Having Sulfamic Acid Salt as Main Ingredient (Comparative Example 4)

After guanidine sulfamate was diluted to a solid concentration of 30% in distilled water, a 1.0% distearyl dimethyl benzyl ammonium bromide as a cationic surfactant was added thereto to thereby prepare a wood preservative composition having guanidine sulfamate as a main ingredient.

The ingredients of the wood preservative compositions of Examples 3 to 6 and Comparative Examples 1 to 4 are shown in Table 4 below.

TABLE 4

| | Hydrazine borate | Surfactant | Flame-retardant aid |
|---|---|---|---|
| Example | Hydrazine borate | Benzalkonium | — |
| 3 | solution #8 | chloride | |
| Example | Hydrazine borate | Salt of | Ammonium |
| 4 | solution #8 | dodecylbenzenesulfonic | phosphate |
| | | acid | |
| Example | Hydrazine borate | Sodium alpha-olefin | DOT |
| 5 | solution #8 | sulfonate | |
| Example | Hydrazine borate | Dynel 604 | Ammonium amino |
| 6 | solution #8 | | trimethylene |
| | | | phosphonate |
| Comparative | — | — | Triethanolamine |
| Example | | | phosphate |
| 1 | | | |
| Comparative | — | — | Ammonium |
| Example | | | nitrilotris(methylene)tris- |
| 2 | | | phosphonate |
| Comparative | — | — | DOT |
| Example | | | |
| 3 | | | |
| Comparative | — | Distearyl dimethyl | Guanidine sulfamate |
| Example | | benzyl ammonium | |
| 4 | | chloride | |

### Experimental Example 1: Test on Flame-Retardant Performance

The solutions of Examples 4, 5, and 6 were tested for flame-retardant performance.

Specifically, the wood preservative compositions of Examples 4, 5, and 6 were sprayed by using a simplified sprayer on surfaces of three sheets of plywood (specimens) of 190 mm in width, 290 mm in length, and 5 mm in thickness, corresponding to Grade 2 of KS F 3101 (normal plywood) once, respectively. The plywood sheets were left standing at room temperature for 48 hours, and then sprayed once more. The average throughput was 139.4 g/m² for the first treatment and 111.3 g/m² for the second treatment.

Thereafter, the flame-retardant performance was tested according to the “standards and methods for measuring flame-retardant performance of synthetic resin boards and plywood” of Article 7 of the “standards for flame-retardant performance (KOFEIS 1001)” by the Korea Fire Institute. According to the methods, after a sample is heated by a maker burner for 2 minutes and then the flame of the burner is removed, the time until a state of burning with flame stops is defined as “afterflame time”; the time until a state of burning without flame stops is defined as “afterglow time”; the area carbonized during the test is defined as “char area”; and the carbonized length is defined as “char length”. The acceptance standards according to KOFEIS 1001 are an afterflame time of 10 seconds or less, an afterglow time of 30 seconds or less, a char length of 20 cm or less, and a char area of 50 cm² or less. The average values of the afterflame time, afterglow time, char time, and char area after the test on flame retardancy are shown in Table 5.

TABLE 5

| | Char area | Char length | Afterflame | Afterglow |
|---|---|---|---|---|
| | (cm²) | (cm) | time (s) | time (s) |
| BAE (wt %) | | | | |
| 24 | 34.7 | 8.7 | 4.5 | 0 |
| 18 | 38.6 | 9.2 | 3.4 | 0 |
| 12 | 38.4 | 9.6 | 4.0 | 0 |
| Preservation | | | | |
| treatment solution | | | | |
| Example 4 | 37.0 | 8.9 | 1.0 | 0 |
| Example 5 | 36.4 | 7.2 | 0.0 | 0 |
| Example 6 | 42.3 | 8.0 | 2.5 | 0 |
| No treatment | 89.7 | 17.2 | 200↑ | 200↑ |

The results identified that the untreated plywood was beyond the flame-retardant performance acceptance standards, but hydrazine borates having at least 12 wt % BAE or the wood preservative compositions of Examples 4, 5, and 6 showed excellent flame-retardant effects when used to treat plywood.

### Experimental Example 2: Test on Discoloration Resistance

The hydrazine borate solution of #8 in Example 2 was diluted to an effective boric acid content of 20 wt %, and the diluted solution was sprayed on specimens, which were manufactured by printing Pinus densiflora wood samples of 70 mm in length, 150 mm in height, and 5 mm in thickness with 13 dancheong colors, respectively, or as a bare wood state of the wood sample. Spraying was conducted a total of two times by first spraying and, after 48 hours, second spraying. After the final spraying, the specimens were dried by standing vertically in a well-ventilated place for 7 days, followed by measurement. As for a control group, distilled water, not the preservative, was applied by way of the same method as above.

Regarding discoloration resistance, L*, a*, and b* values of each of the specimens before and after the treatment with the preservative were measured using a colorimeter, and the extents of change were compared by ΔL*, Δa*, Δb*, and ΔE* values. Of these, L*, a brightness index, is 100 for white and 0 for black, and a* and b*, chromacheckness indices, indicate hue and saturation. ΔE* was calculated using the equation below.

ΔE*=\sqrt{(ΔL*)²+(Δa*)+(Δb*)²}

In the equation, ΔL*, Δa*, and Δb* are the changes of L*, a*, and b* before and after the preservative treatment.

The results of evaluation according to standards of the degree of color difference as shown in Table 6 below are shown in Table 7.

TABLE 6

| Degree of color difference | ΔE* |
|---|---|
| Extremely small difference | 0-0.5 |
| Small difference | 0.5-1.5 |
| Perceptible difference | 1.5-3.0 |
| Significant difference | 3.0-6.0 |
| Extremely significant difference | 6.0-12.0 |
| Other colors | 12.0 or more |

TABLE 7

| | Color | | Color |
|---|---|---|---|
| | difference | | difference |
| Dancheong color | (ΔE*) | Dancheong color | (ΔE*) |
| Blue green | 0.61 | Vermilion (juhong) | 0.15 |
| (noelog) | | | |
| Pea green | 1.80 | White (jidang) | 0.07 |
| (yanglog) | | | |
| Orange (jangdan) | 1.24 | Greenish brown | 1.88 |
| | | (hayeob) | |
| Navy blue | 2.46 | Reddish brown | 1.94 |
| (guncheong) | | (daja) | |
| Sky blue | 1.87 | Apricot (yugsaeg) | 2.53 |
| (samcheong) | | | |
| Chrome yellow | 0.08 | Black (meog) | 0.04 |
| (sukhwang) | | | |
| Brown (sukganju) | 0.21 | Bare wood | 2.78 |
| | | (baeggol) | |

The description in parentheses above is the Korean pronunciation in English.

### Experimental Example 3: Test on Whitening Resistance

5 g of seashell powder was added to 100 g of each of the solutions of #2 of Example 1 and Comparative Example 1. While the mixture was stirred at room temperature, a portion of solids was collected at regular time intervals, separated into solids and a liquid by a centrifuge, washed and dried three times, and then subjected to infrared spectrum measurement. The results of measuring the proportion of the original seashell powder and the produced calcium phosphate tribasic salt are shown in Table 8.

TABLE 8

| | 30 | | | | |
|---|---|---|---|---|---|
| Solution | minutes | 2 hours | 8 hours | 12 hours | 72 hours |
| #2 of Example 1 | 0% | 0% | 0% | 0% | 0% |
| Comparative | 10% | 30% | 90% | 100% | — |
| Example 1 | | | | | |

In addition, as a result of testing the solution of Comparative Example 2 in the same manner as above, the seashell powder was dissolved with bubbling of carbonic acid gas to change to a transparent solution. It was expected that the seashell powder was dissolved by a metal ion sequestering action of nitilotris(methylene)triphosphonic acid and thus was transparent.

Referring to Table 8, in the solution prepared in Comparative Example 1, calcium carbonate as a main component of seashell powder reacted with triethanolamine phosphate to start to change to calcium phosphate after 30 minutes, and all changed to calcium phosphate after 12 hours. However, in the hydrazine borate solution prepared in #2 of Example 1, the form of calcium carbonate was maintained even after 72 hours, indicating that hydrazine borate did not react with calcium carbonate and thus had an excellent whitening-resistant effect.

### Experimental Example 4: Test on Mold-Proof Effect

For five species of test strains, Aspergillus niger (ASN), Penicillium funiculosum (PEC)], Rhizopus nigricans (RHN)], and Aureobasidium pullulans (AUP), and Tricoderma vidde (TRV), five species of reference strains isolated by the Forest Research Institute (FRI) were used.

The solution of Example 3 was sprayed onto specimens by way of the same method as in Experimental Example 3 so that the average amount of drug application was 120 g/m² (6 specimens being used for each strain). After each strain was cultured at a temperature of 26° C.±2° C. and a relative humidity of 70-80% for 4 weeks, the growth condition of cells in each specimen was observed, and evaluation values were obtained according to the standards in Table 9 below, and the results are shown in Table 10.

TABLE 9

| Evaluation | |
|---|---|
| value | Growth condition of cells |
| 0 | No mold growth was observed in specimen. |
| 1 | Mold growth was observed on side of specimen. |
| 2 | Mold growth was observed on ⅓ or less of top surface |
| | of specimen. |
| 3 | Mold growth was observed on ⅓ or more of top |
| | surface of specimen. |

TABLE 10

| Terms | ASN | PEC | RHN | AUP | TRV |
|---|---|---|---|---|---|
| Example 3 | 0 | 0 | 0 | 0 | 0 |
| No treatment | 3 | 3 | 3 | 3 | 3 |

The results confirmed that in cases of no treatment, mold growth was observed on ⅓ or more of the top surface of the specimen regardless of the species of test strains, but in cases of treatment with the solution of Example 3, no mold growth was observed, showing excellent mold-proof effects.

### Experimental Example 5: Test on Rot-Resistant Effect

The solution of Example 3 was tested on the brown rot fungus Tyromyces palustris and the white rot fungus T. versicolor for three weeks according to the test method specified in KS M-1701 Wood Preservatives (2010). Thereafter, the average weight reduction rates of specimens were obtained, and the results are shown in Table 11. According to KS M-1701, an average weight reduction rate of 3% or less is defined as the standard for achieving rot-resistant performance.

TABLE 11

| | | Amount of chemical | Average weight |
|---|---|---|---|
| Classification | Solution | application (g/m²) | reduction rate (%) |
| White rot | Example 3 | 110.4 | 0.19 |
| fungus | | | |
| No treatment | — | — | 4.95 |
| Brown rot | Example 3 | 111.0 | 0.00 |
| fungus | | | |
| No treatment | — | — | 5.82 |

The results confirmed that in cases of no treatment, the average weight reduction rates of the white rot fungus and the brown rot fungus were 4.95% and 5.82%, respectively, both of which exceed 3.0%. However, in cases of treatment with the solution of Example 3, the average weight reduction rates of the fungi were 0.19% and 0.00%, respectively, indicating excellent rot-resistant effects.

### Experimental Example 6: Test on Insect-Repellent Effect

In a container, each specimen sprayed with the solution of Example 3 was placed and 200 animals of Reticulitermes speratus were placed, and then the container was left standing in a dark place at a temperature of 28° C.±2° C. and Reticulitermes speratus were grown for 3 weeks. The results of obtaining the insecticidal rate and the average weight reduction rate of each specimen are shown in Table 12. Herein, an average weight reduction rate of 3% or less was evaluated as having an insect-repellent effect.

TABLE 12

| | | | Average |
|---|---|---|---|
| | Amount of chemical | Average weight | insecticidal |
| Solution | application (g/m²) | reduction rate (%) | rate (%) |
| Example 3 | 119.4 | 0.46 | 100.0 |
| No treatment | — | 21.9 | 16.6 |

The results confirmed that in cases of no treatment, the average weight reduction rate and the average insecticidal rate were 21.9% and 16.6%, respectively. However, in cases of treatment with the solution of Example 3, the average weight reduction rate and the average insecticidal rate were 0.46% and 100.0%, respectively, indicating excellent insect-repellent effects.

### Experimental Example 7: Test on Iron Corrosion

Two nails were driven at an interval of 10 mm into pine wood with a size of 200 mm in width, 40 mm in length, and 5 mm in thickness while the heads of the nails were placed upwards. The test nails are 38 mm in length defined according to KS D 3553, and degreased with benzene and washed with ethanol before use. Each of the solutions of Example 3 and Comparative Example 4 was applied at 110 g/m² on wood. Each wood was placed in a desiccator (inner diameter of 18 cm) previously adjusted to a temperature of 40° C.±2° C. and a relative humidity of about 97% and containing a saturated aqueous solution coexisting with crystals of potassium sulfate while the heads of the nails were placed upwards. Each wood was left for 10 days while the temperature was maintained. After 10 days, the nails were pulled from each specimen and completely immersed in a beaker containing an aqueous solution of ammonium citrate (10%). The beaker was covered with a watch glass and then heated for 20 minutes. The nails were washed, wiped with a cloth, dried, and then weighed to 0.001 g. The weight reduction rate due to nail corrosion was calculated using the following equation.

$$Weight reduction rate ( \% ) = \frac{nail weight before test ( g ) - nail weight after test}{nail weight before test ( g )} \times 100$$

The iron corrosion rate was calculated using inserting the obtained weight reduction rate into the following equation, and these are shown in Table 13.

$$Iron corrosion rate ( \% ) = \frac{average weight reduction rate of nail of treated specimen ( \% )}{average weight reduction rate of nail of untreated specimen ( \% )}$$

TABLE 13

| | | | Iron |
|---|---|---|---|
| | Amount of chemical | Average weight | corrosion |
| Classification | application (g/m²) | reduction rate (%) | rate |
| Example 3 | 116.3 | 0.41 | 0.43 |
| Comparative | 118.2 | 1.68 | 1.75 |
| Example 4 | | | |
| No treatment | — | 0.96 | 1.00 |

The results confirmed that compared with the untreated wood, the iron corrosion rate in the treatment with Example 3 containing hydrazine borate as an ingredient was 0.43, and the iron corrosion rate in the treatment with Comparative Example 4 containing guanidine sulfate as an ingredient was 1.75, indicating an excellent iron corrosion inhibiting effect of hydrazine borate.

### Experimental Example 8: Test on Dilution Stability

As shown in Table 14, #2 of Example 2 having 50.0 wt % BAE and Comparative Example 3 having an effective boric acid content of 48.0 wt % were diluted in distilled water, and 40 mL of each was placed in a 50 mL polyethylene tube. The precipitation or lack thereof over time was visually observed while the tube was shaken every 6 hours, and the results are shown in Table 14.

TABLE 14

| | 1:1 | | 2:1 | | 3:1 | |
|---|---|---|---|---|---|---|
| Elapsed | #2 of | Comparative | #2 of | Comparative | #2 of | Comparative |
| days | Example 2 | Example 3 | Example 2 | Example 3 | Example 2 | Example 3 |
| 1 Days | N | N | N | N | N | N |
| 3 Days | N | S | N | N | N | N |
| 5 Days | N | M | N | S | N | N |
| 7 Days | N | H | N | H | N | N |

N = No precipitate
S = Small amount of precipitates
M = Moderate amount of precipitates
H = High amount of precipitates

As a result, precipitates were not formed over time regardless of the dilution concentration in #2 of Example 2, but precipitates were formed over time when Comparative Example 3 was diluted to 1:1 or 2:1. The reason for the results was considered to be that the stability of Comparative Example 3 was maintained due to viscosity even in a supersaturated state of DOT, but when Comparative Example 3 was diluted, DOT exceeded the original solubility thereof due to a decrease in viscosity, thereby forming precipitates.

It can be seen from the above experimental test results that the composition of the present invention has excellent effects in terms of flame retardancy, discoloration resistance, whitening resistance, rot resistance, insect repellence, and inhibition of weight reduction caused by iron corrosion, and thus has superior effects in wood preservation.

While the present invention has been described with reference to the particular illustrative embodiments, those skilled in the art to which the present invention pertains can understand that the present invention may be embodied in other specific forms without departing from the technical spirit or essential characteristics thereof. Therefore, the embodiments described above shall be construed as being exemplified and not limiting the present invention in any aspect. The scope of the present invention is not defined by the detailed description as set forth above but by the accompanying claims of the invention, and it should also be understood that all changes or modifications derived from the definitions and scopes of the claims and their equivalents fall within the scope of the invention.

1. A method for wood preservation treatment, the method comprising treating wood with a wood preservative composition comprising a compound prepared using hydrazine hydrate and boric acid at a reaction molar ratio of 1:1-10.

2. The method of claim 1, wherein the compound includes at least one selected from a stereoisomer thereof or a salt thereof.

3. The method of claim 1, wherein the composition further comprises a surfactant and a flame-retardant aid.

4. The method of claim 1, wherein the composition comprises 3 wt % to 70 wt % of the compound, 0.01 wt % to 5 wt % of a surfactant, and 0 wt % to 15 wt % of a flame-retardant aid.

5. The method of claim 4, wherein the surfactant is at least one selected from the group consisting of an anionic surfactant, a cationic surfactant, and a non-ionic surfactant.

6. The method of claim 5, wherein the anionic surfactant is at least one selected from the group consisting of an alkali salt of dodecylbenzenesulfonic acid, an alkali salt of an alpha-olefin sulfonic acid, an alkali salt of an alkyl benzene sulfonic acid, an alkali salt of a dialkylsulfosuccinic acid; an alkali salt of an alkyl phosphate, an alkali salt of an aminophosphonic acid, an alkali salt of an alkyl naphthalene acid, and an alkali salt of an alkyl allyl ether.

7. The method of claim 5, wherein the cationic surfactant is at least one selected from the group consisting of a quaternary ammonium salt having a structure of an alkyl group or aromatic group with 8 to 18 carbon atoms, a fatty acid amine acetate with 8 to 18 carbon atoms, a fatty acid imidazolium methosulfate with 12 to 18 carbon atoms, and a fatty acid imidazolium quaternary compound with 8 to 18 carbon atoms.

8. The method of claim 5, wherein the non-ionic surfactant is at least one selected from the group consisting of an alkyl phenol with 6 to 12 carbon atoms, a fatty acid ester with 12 to 18 carbon atoms, a fatty acid ether with 12 to 18 carbon atoms, a trisiloxane, and an acetylene-structured ethylene oxide adduct, and an amine oxide with 12 to 18 carbon atoms.

9. The method of claim 4, wherein the flame-retardant aid is at least one selected from the group consisting of phosphoric acid or a salt thereof, sulfuric acid or a salt thereof, a halogen acid or a salt thereof, sulfamic acid or a salt thereof, boric acid or a salt thereof, and a phosphonic acid or a salt thereof.

10. The method of claim 9, wherein the salt of phosphoric acid is at least one selected from the group consisting of monoammonium phosphate, diammonium phosphate, triammonium phosphate, monolithium phosphate, dilithium phosphate, trilithium phosphate, monosodium phosphate, disodium phosphate, trisodium phosphate, monopotassium phosphate, dipotassium phosphate, tripotassium phosphate, monoguanidine phosphate, diguanidine phosphate, a low-condensed ammonium polyphosphate with a condensation degree of 2-200, guanyl urea phosphate, an amine salt of phosphoric acid, and a hydrazine salt of phosphoric acid.

11. The method of claim 9, wherein the salt of sulfuric acid is at least one selected from the group consisting of ammonium sulfate, lithium sulfate, sodium sulfate, potassium sulfate, an amine salt of sulfuric acid, and a hydrazine salt of sulfuric acid.

12. The method of claim 9, wherein the salt of the halogen acid is at least one selected from the group consisting of ammonium chloride, lithium chloride, sodium chloride, potassium chloride, ammonium bromide, sodium bromide, potassium bromide, an amine salt of the halogen acid, and a hydrazine salt of the halogen acid.

13. The method of claim 9, wherein the salt of sulfamic acid is at least one selected from the group consisting of guanidine sulfamate, ammonium sulfamate, lithium sulfamate, sodium sulfamate, potassium sulfamate, an amine salt of sulfamic acid, and a hydrazine salt of sulfamic acid.

14. The method of claim 9, wherein the salt of boric acid is at least one selected from the group consisting of boric acid, borax, boron oxide, potassium pentaborate (KB5O7), potassium tetraborate (K2B4O7), sodium metaborate (NaBO2), ammonium pentaborate ((NH4)2B10O16·8H2O), sodium octaborate (Na2B8O13), lithium octaborate (Li2B8O13), magnesium octaborate (MgB8O13), calcium octaborate (CaB8O13), and an amine salt of boric acid.

15. The method of claim 9, wherein the salt of phosphonic acid is at least one selected from the group consisting of amino trimethylene phosphonic acid, 1-hydroxyethylene-1,1-diphosphonic acid, ethylene diamine tetramethylene phosphonic acid, hexamethylene diamine tetramethylene phosphonic acid, diethylene triamine pentamethylene phosphonic acid, and 2-phosphonobutane-1,2,4-tricarboxylic acid.

16. The method of claim 1, wherein the composition has at least one effect selected from the following:
i) flame-retardant effect;
ii) discoloration-resistant effect;
iii) whitening-resistant effect;
iv) mold-proof effect;
v) rot-resistant effect;
vi) insect-repellent effect; and
vii) iron corrosion inhibiting effect.
